(19) United States
(12) Patent Application Publication
(10) Pub. No.: US 2013/0175126 A1
(43) Pub. Date: Jul. 11, 2013

(54) DISC ROTOR

(71) Applicant: Takashi Harada, Toyota-shi (JP)

(72) Inventor: Takashi Harada, Toyota-shi (JP)

(73) Assignee: ADVICS CO., LTD., Kariya-city ,Aichi-pref (JP)

(21) Appl. No.: 13/822,947

(22) PCT Filed: Oct. 18, 2011
(86) PCT No.: PCT/JP2011/073887

§ 371 Date: Mar. 13, 2013

(30) Foreign Application Priority Data
Oct. 28, 2010 (JP) 2010-241922

(51) Int. Cl. F16D 65/12

(52) U.S. Cl. CPC F16D 65/127
USPC 188/218 XL

(57) ABSTRACT

A disc rotor 10 has an annular sliding portion 11 and a hat portion 12 integrally provided at the inner periphery of the sliding portion 11. The sliding portion 11 has an annular braking portion 11a which is nipped between front and back friction pads 20 at the time of braking. A plurality of circular non-penetrating holes 11a2 are provided on front and back annular contact surfaces S of the braking portion 11a of the sliding portion 11 against which friction materials 21 of the corresponding brake pads 20 are pressed at the time of braking. The centers of the non-penetrating holes 11a2 are located at different positions in the rotor radial direction. The non-penetrating holes 11a2 are disposed at predetermined intervals in the rotor circumferential direction. Thus, it becomes possible to reduce the amount of wear of the friction materials 21 caused by the circular non-penetrating holes 11a2 (provided for restraining fading which occurs due to gas generated from the friction materials of the brake pads through thermal decomposition caused by friction heat at the time of braking).

### TECHNICAL FIELD

The present invention relates to a disc rotor of a disc brake apparatus which is employed, for example, in a vehicle so as to brake the wheels thereof.

### BACKGROUND ART

For example, Patent Document 1 discloses a disc rotor of this type which has a plurality of circular non-penetrating holes (dimples) provided on an annular contact surface of the disc rotor against which the friction material of a brake pad is pressed at the time of braking.

### Prior Art Document

### Patent Document

Patent Document 1: Japanese Patent Application Laid-Open (kokai) No. S58-94646

In the case of the disc rotor disclosed in the above-mentioned Patent Document 1, gas generated from the friction material of the brake pad through thermal decomposition thereof caused by friction heat at the time of braking (hereinafter, the gas will be referred to as “gas produced through thermal decomposition”) can be released to the non-penetrating holes, whereby fading caused by the gas produced through thermal decomposition can be restrained.

### SUMMARY OF THE INVENTION

Incidentally, in the disc rotor disclosed in the above-mentioned Patent Document 1, a plurality of (for example, 6) sets each including a plurality of (for example, 5) non-penetrating holes disposed in a predetermined pattern are disposed at predetermined intervals in the circumferential direction of the rotor (hereinafter referred to as the rotor circumferential direction). Therefore, every time the disc rotor rotates one revolution, the centers of a plurality of (6 corresponding to the number of the sets) non-penetrating holes slidingly pass through the same location of the friction material of the brake pad, and the amount of wear of the friction material may increase.

The present invention was made so as to solve the above-described problem, and provides a disc rotor having a plurality of circular non-penetrating holes provided on an annular contact surface against which a friction material of a brake pad is pressed at the time of braking, wherein the centers of the non-penetrating holes are located at different positions in the rotor radial direction (the disc rotor according to the invention of claim 1).

In this disc rotor (the disc rotor according to the invention of claim 1), since the centers of the non-penetrating holes are located at different positions in the rotor radial direction, the centers of the plurality of non-penetrating holes do not slidingly pass through the same location of the friction material of the brake pad every time the disc rotor rotates one revolution. Therefore, as compared with the conventional disc rotor, the amount of wear of the friction material can be reduced.

When the above-described invention is implemented, the non-penetrating holes may be disposed at predetermined intervals in the circumferential direction of the rotor (hereinafter referred to as the rotor circumferential direction) (the invention of claim 2). In this case, by means of properly setting the number of the non-penetrating holes, the non-penetrating holes can be disposed over the entire circumference of the rotor. Thus, the friction material of the brake pad comes into pressure contact with at least one non-penetrating hole irrespective of the rotation state of the disc rotor. Therefore, even in any rotation state of the disc rotor, fading caused by gas produced through thermal decomposition can be restrained effectively.

When the above-described invention is implemented, rotation loci of the non-penetrating holes may partially overlap one another (the invention of claim 3). The amount of overlapping in the rotor radial direction between adjacent rotation loci may be smaller than the radius of the non-penetrating holes (the invention of claim 4). In these cases, by means of properly setting the size (diameter) and number of the non-penetrating holes, it becomes possible to cause the non-penetrating holes to come into sliding engagement with the entire surface of the friction material of the brake pad at least once every time the disc rotor rotate one revolution, and to cause the friction material to wear uniformly in the rotor radial direction as a result of sliding engagement of the non-penetrating holes with the friction material (at the centers of the non-penetrating holes, the friction material projects into the non-penetrating holes in a greater amount and wears in a greater amount, as compared with the projection and wear of the friction material at the inner and outer portions of the non-penetrating holes with respect to the rotor radial direction). Therefore, it is possible to restrain partial wear of the friction material of the brake pad, while reducing the amount of wear of the friction material.

### BRIEF DESCRIPTION OF THE DRAWINGS

FIG. 1 is a front view showing one embodiment of a disc rotor according to the present invention.

FIG. 2 is a sectional view of the disc rotor shown in FIG. 1, taken along line A-A.

FIG. 3 is an imaginary view showing a state in which all the non-penetrating holes shown in FIG. 1 are moved in the rotor circumferential direction and are aligned in the rotor radial direction such that the positions of all the non-penetrating holes in the rotor circumferential direction coincide with that of one non-penetrating hole (e.g., the non-penetrating hole provided at the outermost position of the annular contact surface).

FIG. 4 is an enlarged view of a non-penetrating hole shown in FIG. 2 (a non-penetrating hole shown in cross section).

FIG. 5 is an imaginary view corresponding to FIG. 3 and showing another embodiment of the disc rotor according to the present invention (an embodiment in which the non-penetrating holes aligned in the rotor radial direction are in contact with one another).

FIG. 6 is an imaginary view corresponding to FIG. 3 and showing another embodiment of the disc rotor according to the present invention (an embodiment in which the non-penetrating holes aligned in the rotor radial direction are spaced from one another by a predetermined amount.

### MODE FOR CARRYING OUT THE INVENTION

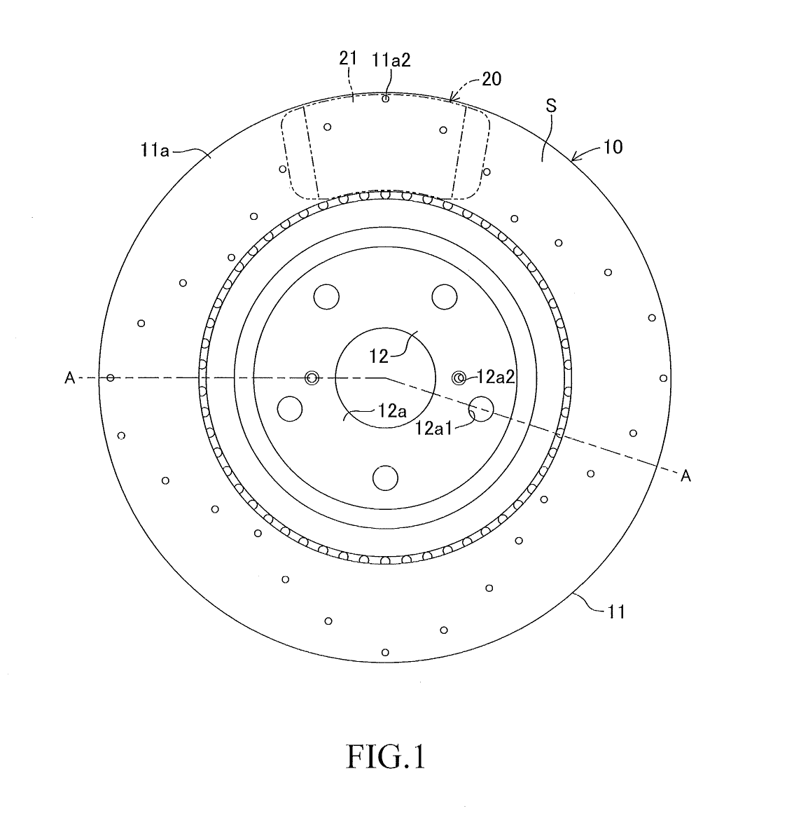

Embodiments of the present invention will now be described with reference to the drawings. FIGS. 1 to 4 show one embodiment of a disc rotor according to the present invention. The disc rotor 10 of this embodiment is a disc rotor of a disc brake apparatus employed in a vehicle so as to brake a wheel. The disc rotor 10 is formed of, for example, cast iron (iron-based metallic material), and has an annular sliding portion 11 and a hat portion 12 integrally provided at the inner periphery of the sliding portion 11.

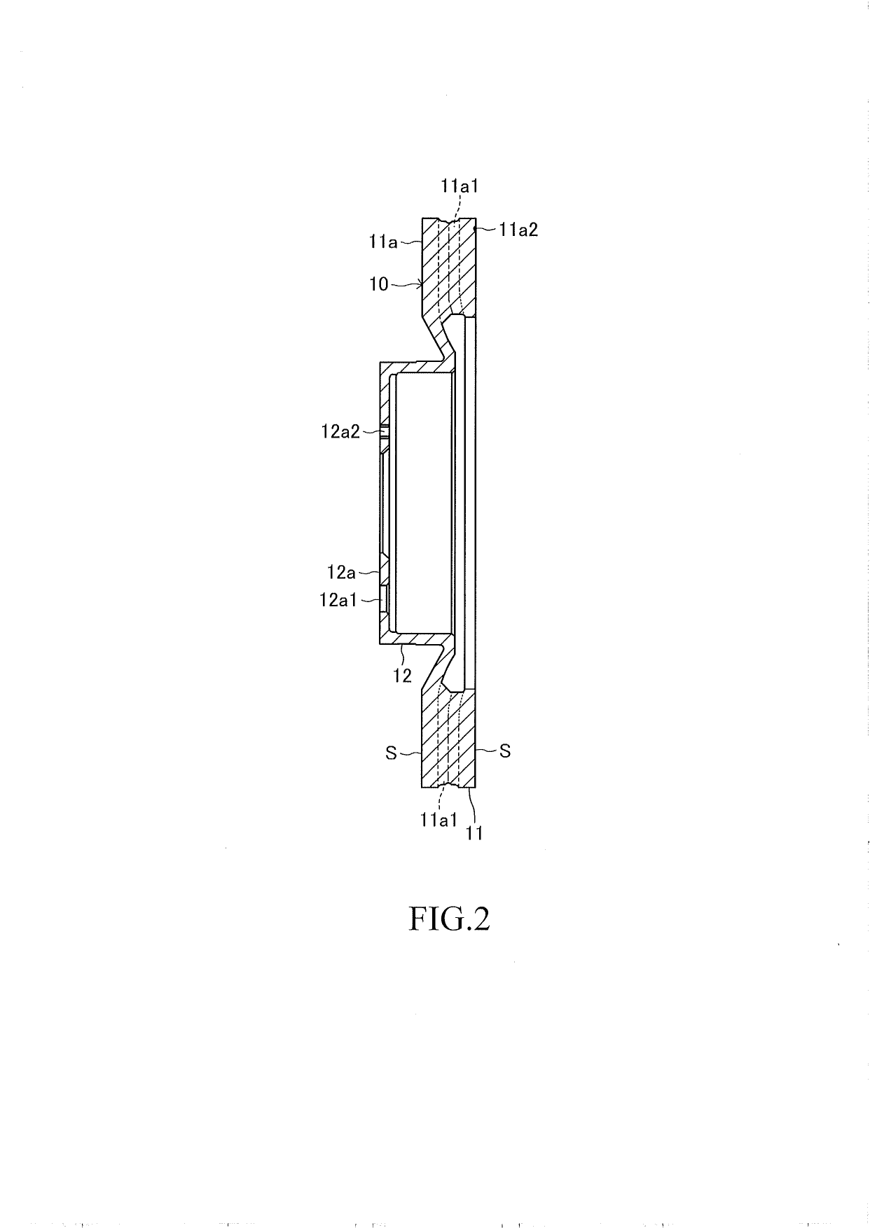

As shown in FIGS. 1 and 2, the sliding portion 11 has an annular braking portion 11a, which is nipped between front and back friction pads 20 (see imaginary lines in FIG. 1) in a known manner at the time of braking. The braking portion 11a has a large number of ventilation passages 11a1 formed therein. Each of the ventilation passages 11a1 is formed such that, when the disc rotor 10 rotates in the normal direction (when the vehicle moves forward), the ventilation passage causes air to flow from one end of the passage at the outer periphery to the other end thereof at the inner periphery.

As shown in FIGS. 1 and 2, the hat portion 12 has an annular inward flange 12a which is fixed to a wheel hub (not shown). The inward flange 12a has five mounting holes 12a1 which are formed at equal intervals in the rotor circumferential direction and are used for fixation to the wheel hub (not shown). Also, the inward flange 12a has two service threaded holes 12a2 formed at equal intervals in the rotor circumferential direction. In the case where the disc rotor 10 and the wheel hub (not shown) are locked together because of rust generated therebetween after use of the disc rotor 10, bolts having the same size as that of the service threaded holes 12a2 can be screwed into the service threaded holes 12a2 so as to separate the disc rotor 10 from the wheel hub (not shown).

Incidentally, in this embodiment, 28 circular non-penetrating holes 11a2 are provided on each of front and back annular contact surfaces S of the braking portion 11a of the sliding portion 11 against which the friction materials 21 of the corresponding brake pads 20 are pressed at the time of braking. As shown in FIG. 1, the non-penetrating holes 11a2 are disposed at predetermined intervals (equal intervals or unequal intervals) in the rotor circumferential direction such that at least two (three in the state of FIG. 1) non-penetrating holes 11a2 overlap the friction materials 21 irrespective of the rotation state of the disc rotor 10. Notably, the non-penetrating holes 11a2 are disposed in an arbitrary layout on the front and back sides (the layouts on the front and back sides may be identical with or differ from each other).

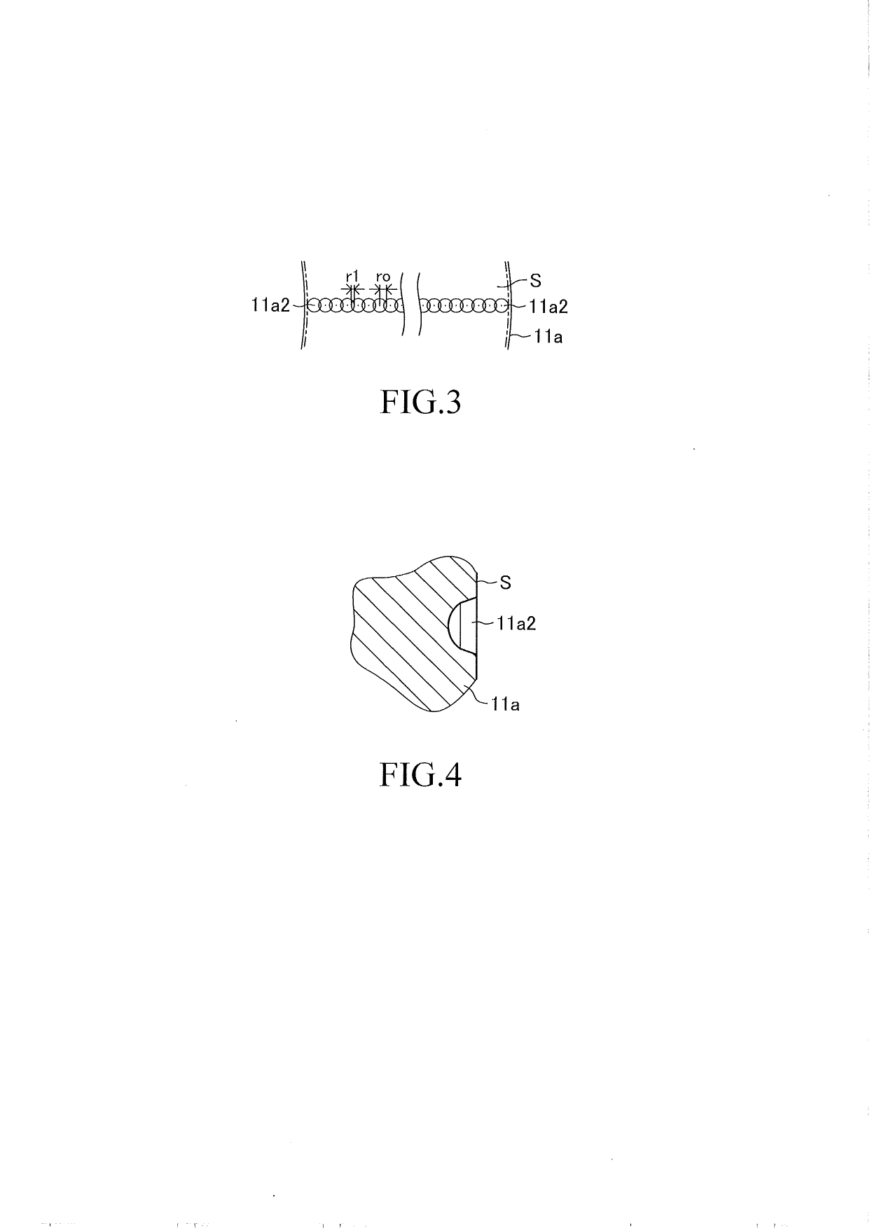

In this embodiment, as shown in FIGS. 1 and 3, the centers of the non-penetrating holes 11a2 (indicated by “.” in FIG. 3) are located at different positions in the rotor radial direction, and the rotation loci of the non-penetrating holes 11a2 (loci formed as a result of rotation of the disc rotor 10) (partially) overlap one another by a predetermined amount. As shown in FIG. 3, the overlapping amount r1 between the rotation loci of adjacent non-penetrating holes 11a2, as measured in the rotor radial direction, is set to be smaller than the radius ro of the non-penetrating holes 11a2. The non-penetrating hole 11a2 illustrated at the right end of FIG. 3 is the non-penetrating hole provided at the outermost position of the annular contact surface S, and the non-penetrating hole 11a2 illustrated at the left end of FIG. 3 is the non-penetrating hole provided at the innermost position of the annular contact surface S. In FIG. 3, the 28 non-penetrating holes 11a2 are aligned in the rotor radial direction with no spacing formed therebetween.

In this embodiment, the non-penetrating holes 11a2 are formed in a process of casting the disc rotor 10. As shown in FIG. 4, a bottom portion of each non-penetrating hole 11a2 has a hemispherical shape, and an opening-side end portion thereof has a tapered shape in consideration of die removal. The volume (diameter and depth) of each non-penetrating hole 11a2 is set in consideration of the amount of gas generated from the friction material 21 of each brake pad 20 through thermal decomposition caused by friction heat at the time of braking, so that the penetrating holes 11a2 can accommodate the gas produced through thermal decomposition to a necessary and sufficient degree.

In the disc rotor 10 of this embodiment having the above-described configuration, a plurality of circular non-penetrating holes 11a2 are provided on each of the annular contact surfaces S against which the friction materials 21 of the brake pads 20 are pressed at the time of braking. Therefore, the gas generated from the friction materials 21 of the brake pads 20 through thermal decomposition caused by friction heat at the time of braking can be released to the non-penetrating holes 11a2 of the disc rotor 10, whereby fading caused by the gas produced through thermal decomposition can be restrained.

In the disc rotor 10 of this embodiment, since the centers of the non-penetrating holes 11a2 are located at different positions in the rotor radial direction, the centers of the plurality of non-penetrating holes 11a2 do not slidingly pass through the same location of the friction materials 21 of the respective brake pads 20 every time the disc rotor 10 rotates one revolution. Therefore, as compared with the conventional disc rotor, the amount of wear of the friction materials 21 can be reduced.

In the disc rotor 10 of this embodiment, since the 28 non-penetrating holes 11a2 are disposed at predetermined intervals in the rotor circumferential direction, the non-penetrating holes 11a2 can be disposed over the entire circumference of the rotor. Thus, the friction material 21 of each brake pad 20 comes into pressure contact with at least two non-penetrating holes 11a2 irrespective of the rotation state of the disc rotor 10. Therefore, even in any rotation state of the disc rotor 10, fading caused by the gas produced through thermal decomposition can be restrained effectively.

In the disc rotor 10 of this embodiment, the centers of the 28 non-penetrating holes 11a2 are located at different positions in the rotor radial direction such that, as shown in FIG. 3, the non-penetrating holes 11a2 are provided over the entire annular contact surface S with respect to the rotor radial direction. Also, the rotation loci of the non-penetrating holes 11a2 overlap one another by a predetermined amount, and the overlapping amount r1 between the rotation loci of adjacent non-penetrating holes 11a2 is set to be smaller than the radius ro of the non-penetrating holes 11a2. Therefore, it is possible to cause the non-penetrating holes 11a2 to come into sliding engagement with the entire surfaces of the friction materials 21 of the brake pads 20 at least once every time the disc rotor 10 rotates one revolution, and to cause the friction materials 21 to wear uniformly in the rotor radial direction as a result of sliding engagement of the non-penetrating holes 11a2 with the friction materials 21 (at the centers of the non-penetrating holes 11a2, the friction materials 21 project into the non-penetrating holes 11a2 in a greater amount and wear in a greater amount, as compared with the projection and wear of the friction materials 21 at the inner and outer portions of the non-penetrating holes with respect to the rotor radial direction). Therefore, it is possible to restrain partial wear of the friction materials 21 of the brake pads 20, while reducing the amount of wear of the friction materials 21.

In the above-described embodiment, 28 non-penetrating holes 11a2 are provided on each of the annular contact surfaces S of the disc rotor 10. However, the number of the non-penetrating holes 11a2 can be changed freely, and is not limited to the number employed in the above-described embodiment. In the above-described embodiment, the non-penetrating holes 11a2 are provided over the entire circumference of each annular contact surface S. However, the non-penetrating holes may be provided over only a portion (e.g., a half or a quarter) of the circumference of each annular contact surface S.

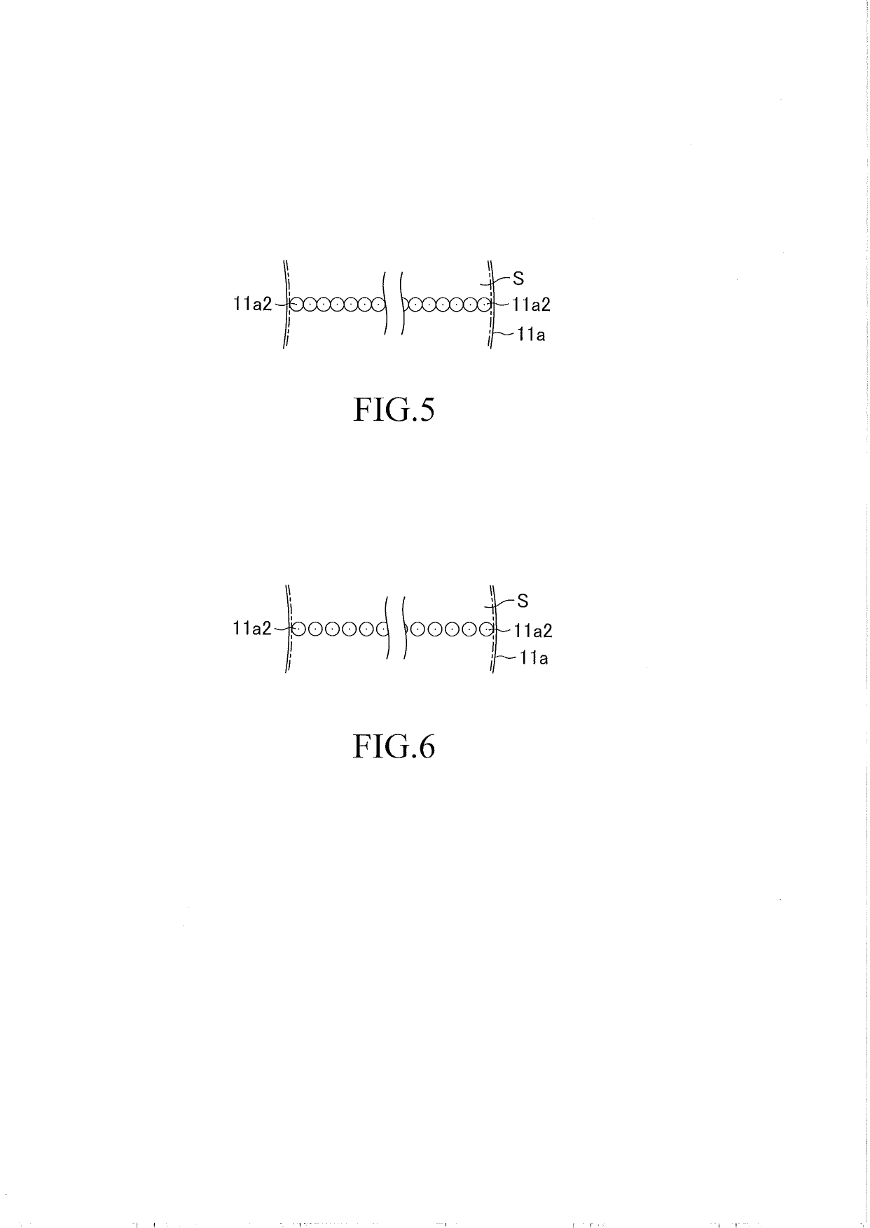

In the above-described embodiment, as shown in FIG. 3, the rotation loci of the non-penetrating holes 11a overlap one another by a predetermined amount. However, as shown in FIG. 5 or FIG. 6, the non-penetrating holes 11a may be provided such that the rotation loci of the non-penetrating holes 11a do not overlap one another. In the embodiment shown in FIG. 5, the non-penetrating holes 11a are provided such that the rotation loci of the non-penetrating holes 11a are in contact with one another in the rotor radial direction. In the embodiment shown in FIG. 6, the non-penetrating holes 11a are provided such that the rotation loci of the non-penetrating holes 11a are spaced from one another in the rotor radial direction by a predetermined amount.

In the above-described embodiment, since the disc rotor 10 having the ventilation passages 11a1 provided between the front and back sides of the disc rotor 10 and having a relatively large thickness is used for four-wheel vehicles, the layout of the non-penetrating holes 11a2 on the front side and that on the back side are determined arbitrarily (can be changed freely). However, in the case of a disc rotor which has no ventilation passages (11a1) between the front and back sides of the disc rotor and has a relatively small thickness, such as those used for two-wheel vehicles, from the viewpoint of securing strength, preferably, the positions of the non-penetrating holes (11a2) formed on the front side are shifted from the positions of the non-penetrating holes (11a2) formed on the back side in the circumferential direction such that the non-penetrating holes 11a2 are located at different positions. Also, the volume (diameter and depth) of each non-penetrating hole 11a2 can be set freely in accordance with the number of the non-penetrating holes 11a2, the amount of gas produced through thermal decomposition at the time of braking, etc.

1. A disc rotor having a plurality of circular non-penetrating holes provided on an annular contact surface against which a friction material of a brake pad is pressed at the time of braking, wherein the centers of the non-penetrating holes are located at different positions in the radial direction of the rotor.

2. A disc rotor according to claim 1, wherein the non-penetrating holes are disposed at predetermined intervals in the circumferential direction of the rotor.

3. A disc rotor according to claim 1, wherein rotation loci of the non-penetrating holes partially overlap one another.

4. A disc rotor according to claim 3, wherein the amount of overlapping in the radial direction between adjacent rotation loci is smaller than the radius of the non-penetrating holes.

5. A disc rotor according to claim 2, wherein rotation loci of the non-penetrating holes partially overlap one another.
